(19) United States
(12) Patent Application Publication
(10) Pub. No.: US 2026/0233103 A1
(43) Pub. Date: Aug. 13, 2026

(54) METHODS FOR GENERATING THREE-DIMENSIONAL, INTERACTIVE GAMES

(71) Applicants: Connor Alan Reed, San Antonio, TX (US); James Smith, Granbury, TX (US); Alexander James Wingate, Austin, TX (US)

(72) Inventors: Connor Alan Reed, San Antonio, TX (US); James Smith, Granbury, TX (US); Alexander James Wingate, Austin, TX (US)

(21) Appl. No.: 19/050,903

(22) Filed: Feb. 11, 2025

(51) Int. Cl. A63F 13/655; A63F 13/52; G06T 17/00

(52) U.S. Cl. CPC A63F 13/655; A63F 13/52; G06T 17/00; G06T 2200/08

(57) ABSTRACT

Methods for generating three-dimensional, interactive games from camera inputs. The methods include creating a virtual representation of an actual scene, generating a virtual scene, generating a game map, associating the virtual scene within the game map as a location a game player may virtually view when virtually navigating the game map. Creating a virtual representation includes receiving image data of the actual scene, processing the image data to generate three-dimensional point clouds, rendering the three-dimensional point clouds into intermediate images comprised of three-dimensional Gaussians, and processing the intermediate images with a deformation field to refine the three-dimensional Gaussians. Generating a virtual scene includes repeating the method for creating a virtual representation at selected intervals to yield time-shifted virtual representations and combining the time-shifted virtual representations to yield the virtual scene.

### BACKGROUND

The present disclosure relates generally to interactive games. In particular, methods of generating three-dimensional, interactive games from camera inputs are described.

Watching videos is a popular pastime. Traditionally, people watched videos on movie screens or televisions. More recently, watching videos on computers, smartphones, tablet computers, and other devices has increased in popularity.

Currently, videos are most often presented in two-dimensions and watched passively. In limited instances, movies and television shows are presented in a three-dimensional format. However, viewing such three-dimensional movies and television shows remains a passive experience with the viewing angles presented limited to the angles of the cameras used to capture the video.

In particular, the viewing angles presented in conventional videos are limited to the angles of the cameras selected by a director of the video. The person viewing conventional videos is presented with a single, director-selected viewing angle even if multiple cameras were used to capture multiple viewing angles.

Video games are popular forms of entertainment, in part, because of the control of the viewing and interactive experience they give the person playing them. In video games, it is often possible to change viewing angles, replay scenes, and interact with elements in the game. It is also usually possible to navigate to different levels within a game and perceive different experiences in each level.

At present, it is complex, labor-intensive, slow, and expensive to generate videos that are more interactive than conventional videos. The complexity, labor, and expense of conventional methods to make videos more interactive limits how many videos can be made interactive. The significant amount of time necessary to add interactive features to videos with conventional methods makes it impossible to distribute interactive videos in anything approaching real-time, such as with live presentations.

With conventional interactive videos, it is often necessary to use virtual reality googles or other specialized devices to experience interactive features. Requiring users to use specialized equipment to experience interactive features like different viewing angles limits how widespread such videos can be distributed and limits who can experience them. It would be beneficial if interactive videos could be experienced with commonly available devices rather than requiring specialized devices.

Thus, there exists a need for methods of generating three-dimensional, interactive games that improve upon and advance the design of known methods of making videos more interactive. Examples of new and useful methods of generating three-dimensional, interactive games relevant to the needs existing in the field are discussed below.

### SUMMARY

The present disclosure is directed to methods for generating three-dimensional, interactive games from camera inputs. The methods include creating a virtual representation of an actual scene captured by camera inputs, generating a virtual scene, generating a game map from camera inputs, associating the virtual scene within the game map as a location a game player may virtually view when virtually navigating the game map to yield a three-dimensional, interactive game.

Creating a virtual representation includes receiving image data of the actual scene from at least two cameras, processing the image data to generate three-dimensional point clouds representing objects in the actual scene for each image frame, rendering the three-dimensional point clouds into intermediate images comprised of three-dimensional Gaussians representing objects in the actual scene for each image frame, and processing the intermediate images with a deformation field to refine the three-dimensional Gaussians that represent objects in motion in the actual scene to yield the virtual representation. The image data includes image frames from each camera.

Generating a virtual scene includes repeating the method for creating a virtual representation at selected intervals to yield time-shifted virtual representations and combining the time-shifted virtual representations to yield the virtual scene.

### BRIEF DESCRIPTION OF THE DRAWINGS

FIG. 1 is a schematic view of a three-dimensional, interactive game being generated from camera inputs with the method shown in FIG. 2.

FIG. 2 is a flow diagram of a first example of a method for generating three-dimensional, interactive games from camera inputs.

FIG. 3 is a flow diagram of creating a virtual representation of an actual scene in the method shown in FIG. 2.

FIG. 4 is a flow diagram of generating a virtual scene in the method shown in FIG. 2.

FIG. 5 is a flow diagram of distributing a three-dimensional, interactive game in the method shown in FIG. 2.

### DETAILED DESCRIPTION

The disclosed methods for generating a three-dimensional, interactive game from camera inputs will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Real-time” means input data is processed within milliseconds so that data outputs are perceived as being instantly available without human perceptible lag.

### Methods for Generating Three-Dimensional, Interactive Games

With reference to the figures, methods for generating three-dimensional, interactive games will now be described. The methods discussed herein function to generate three-dimensional, interactive games from camera inputs. The methods also enable distributing the games generated.

The reader will appreciate from the figures and description below that the presently disclosed methods address many of the shortcomings of conventional methods for making videos more interactive.

For example, the novel methods disclosed herein enable readily transforming a conventional, two-dimensional, passive video scene captured with two or more cameras into interactive experiences. Further, the novel methods enable generating interactive games viewable from any desired angle from video scenes captured by conventional cameras. Conveniently, the novel methods enable the interactive games to be experienced with commonly available devices, such as video game consoles, smart phones, tablets, and general-purpose computers, rather than requiring specialized devices like virtual reality googles.

Importantly, the novel methods discussed herein enable generating interactive, three-dimensional games from camera inputs with significantly less complexity, labor, time, and expense than conventional methods. As a result, the novel methods increase how many videos can feasibly be made interactive. The significantly reduced time required for the novel methods to generate interactive, three-dimensional games makes it possible to distribute interactive games in real-time, such as for live presentations and broadcasts.

### Method Embodiment One

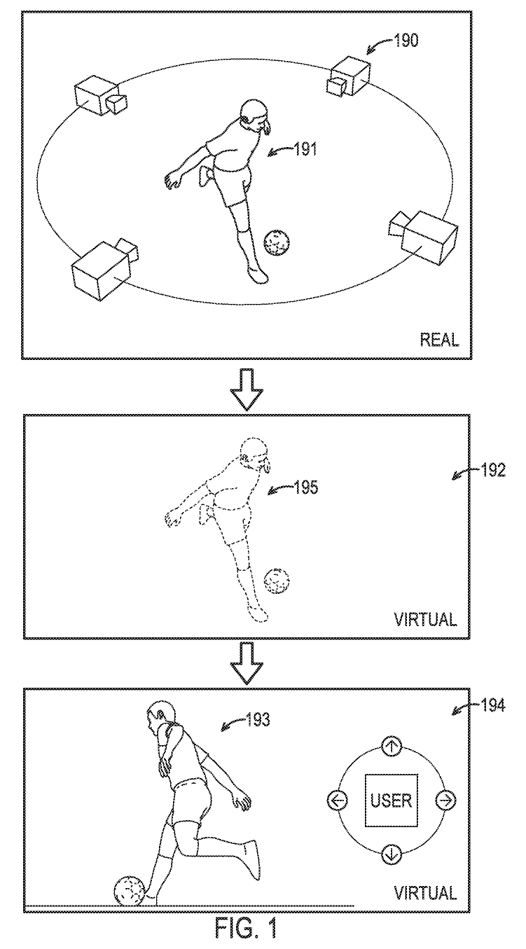

With reference to FIGS. 1-5, a first example of a method to generate interactive, three-dimensional games, method 100, will now be described. As schematically depicted in FIG. 1, method 100 takes video inputs of an actual scene 191 from two or more cameras 190 and generates an interactive, three-dimensional game 194 based on the camera inputs. Method 100 includes multiple steps, which are summarized in the paragraph below and described in more detail in the sections below.

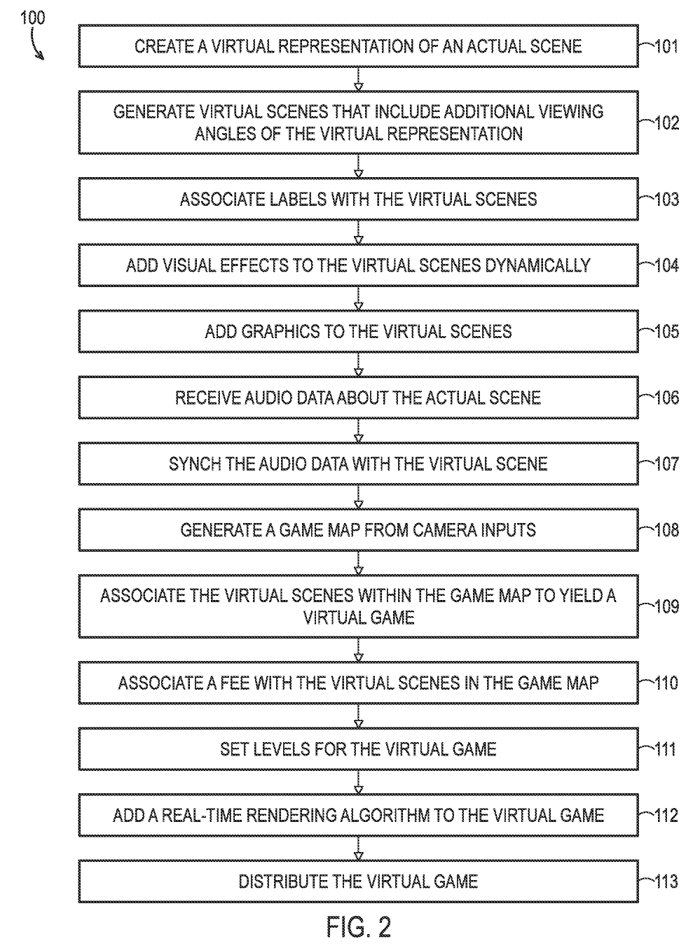

As shown in FIGS. 1 and 2, method 100 includes creating a virtual representation 192 of an actual scene 191 at step 101, generating virtual scenes 193 that include additional viewing angles of the virtual representation at step 102, and associating labels with the virtual scenes at step 103. Method 100 further includes dynamically adding visual effects to the virtual scenes at step 104, adding graphics to the virtual scenes at step 105, and receiving audio data about the actual scene at step 106.

With continued reference to FIGS. 1 and 2 , method 100 additionally includes synching the audio data with the virtual scenes at step 107, generating a game map from camera inputs at step 108, and associating the virtual scenes within the game map to yield a virtual game 194 at step 109. Method 100 further includes associating a fee with the virtual scenes in the game map at step 110, setting levels for the virtual game at step 111, and adding a real-time rendering algorithm to the virtual game at step 112. A step 113 of method 100 involves distributing the virtual game.

In some examples, the method does not include one or more of the steps included in method 100. For example, some method examples do not include one or more of associating labels with the virtual scenes, dynamically adding visual effects to the virtual scenes, and adding graphics to the virtual scenes. Additionally or alternatively, some method examples do not include one or more of receiving audio data about the actual scene, and synching the audio data with the virtual scenes. Moreover, some method examples do not include one or more of associating a fee with the virtual scenes in the game map, setting levels for the virtual game, adding a real-time rendering algorithm to the virtual game, and distributing the virtual game.

In some examples, the method includes additional or alternative steps compared to the steps included in method 100.

### Creating a Virtual Representation

Creating a virtual representation of an actual scene at step 101 begins the process of converting image data from camera inputs into computer manipulatable data. Representing the actual scene in a virtual form allows for more efficiently processing the image data in subsequent steps of method 100. Processing virtual representations of actual scenes captured by cameras with the subsequent steps of method 100 ultimately enables a user to interact with virtual representations of actual scenes, including by changing viewing angles.

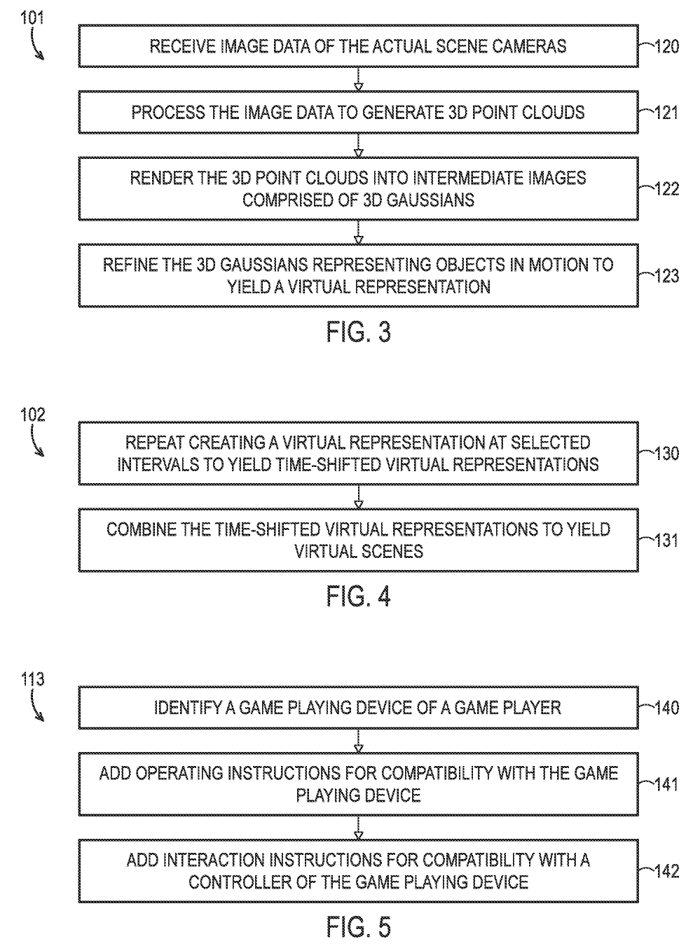

With reference to FIG. 3, the reader can see steps involved with creating a virtual representation of an actual scene at step 101. At step 120, creating a virtual representation at step 101 includes receiving image data of the actual scene. As shown in FIG. 3, creating a virtual representation at step 101 further includes processing image data to generate three-dimensional point clouds at step 121, such as point cloud 195 depicted in FIG. 1. Step 101 further includes rendering the three-dimensional point clouds into intermediate images comprised of three-dimensional Gaussians at step 122 and refining selected three-dimensional Gaussians at step 122. The steps involved with creating a virtual representation at step 101 are discussed in the sections below.

### Receiving Image Data of the Actual Scene

Receiving image data of the actual scene at step 120 supplies raw image data for method 100 to create a virtual representation of the actual scene at step 101. The image data received at step 120 is supplied from at least two cameras. The image data includes image frames from each camera.

The image data received at step 120 is typically videos of actual scenes captured by video cameras, including live camera feeds and previously recorded images. Videos are understood to be a collection of sequential static images collected in a relatively short timeframe, such as 24-120 frames per second. However, faster and slower video framerates may be received at step 120.

The cameras used to capture images at step 120 may be any currently known or later developed type of camera. Suitable cameras include dedicated video cameras 190 shown in FIG. 1 and cameras incorporated into smart phones and other handheld electronic devices. The cameras may be configured to capture and transmit "live" video images in real-time and/or may be configured to record videos for later playback.

The image data may be received at step 120 via wired or wireless data communication means. The image data may be received at the same location where cameras capture a scene or received at locations remote from the actual scene, such as via a data network. In some examples, the image data is received at step 120 by a processor in the same device that includes a camera capturing a scene, such as a smartphone.

### Generating Three-Dimensional Point Clouds

Processing the image data received at step 120 to generate three-dimensional point clouds at step 121 functions to model the actual scene in three dimensions. Modeling the actual scene as a three-dimensional point cloud enables processing the virtual representation of the actual scene more efficiently than the actual image data could be processed. The three-dimensional point cloud model significantly reduces the data necessary to process while maintaining a highly representative depiction of the actual scene.

Processing the image data to generate three-dimensional point clouds at step 121 serves to represent objects in the actual scene from the image data received at step 120. In particular, the three-dimensional point clouds generated at step 121 represents objects for each image frame of the image data received at step 120. Point cloud 195 in FIG. 1 schematically demonstrates how a person and a ball may be represented as a cloud of points. Any currently known or later developed technique for generate three-dimensional point clouds may be used to process the image data at step 121.

### Intermediate Image Rendering

Rendering the three-dimensional point clouds generated at step 121 into intermediate images at step 122 functions to convert the points in the point cloud into three-dimensional Gaussians. Gaussians are raster image components (sometimes described as image particles) characterized by selected image parameters, such as position, covariance, color, and alpha parameters. The three-dimensional Gaussians rendered in step 122 each include position, orientation, scale, opacity, and color parameters.

The three-dimensional Gaussians rendered in step 122 represent objects in the captured actual scene 191 received at step 120. In particular, the three-dimensional Gaussians rendered in step 122 represent objects in the actual scene for each image frame. The objects in the actual scene in each image frame may be stationary or in motion. As described further below, the Gaussians associated with objects in motion may be processed differently than the Gaussians associated with stationary objects.

Rendering the three-dimensional point clouds generated at step 121 into intermediate images comprised of three-dimensional Gaussians at step 122 enables creating virtual representations of actual scenes at step 101 in real-time. Real-time in this context refers to processing time or lag that is generally imperceptible to humans. Three-dimensional Gaussian splatting at step 122 enables processing image data in a highly efficient and fast manner, which is well suited to the interactive, three-dimensional game applications of method 100.

Any currently known or later developed technique for rendering the three-dimensional point clouds generated at step 121 into intermediate images comprised of three-dimensional Gaussians may be used at step 122. Various three-dimensional Gaussian splatting volume rendering and rasterization techniques exist that are suitable for use at step 122. Step 122 may utilize three-dimensional Gaussian splatting, temporal three-dimensional Gaussian splatting, and combinations thereof.

### Refine the Three-Dimensional Gaussians

Refining the three-dimensional Gaussians at step 123 is undertaken to account for objects in motion in the actual scene. The three-dimensional Gaussians processed at step 123 are specifically the three-dimensional Gaussians associated with objects in motion in the actual scene. In some example, three-dimensional Gaussians associated with stationary objects in the actual scene are refined as well, but in the present example, the three-dimensional Gaussians for objects in motion are exclusively selected for further processing in step 123.

The processing undertaken in step 123 is to apply a deformation field to the three-dimensional Gaussians associated with objects in motion in the actual scene. Applying a deformation field to the three-dimensional Gaussians associated with objects in motion functions to represent approximations of elastic deformations the objects in motion are likely to undergo as a result of being subject to dynamic forces.

In the present example, applying a deformation field in step 123 includes applying a function to a matrix describing the position and rotation of each three-dimensional Gaussian in the intermediate images. Any currently known or later developed technique for applying deformation fields to three-dimensional Gaussians may be used in step 123.

Refining the three-dimensional Gaussians that represent objects in motion in the actual scene via a deformation field at step 123 yields a virtual representation of the actual scene. The three-dimensional temporal splatted Gaussians in the virtual representation of the actual scene generated in step 123 more effectively depict virtual representations of dynamic objects in the actual scene. Step 123 may be conducted in real-time.

### Generating Virtual Scenes

As shown in FIG. 1, generating virtual scenes 193 at step 102 adds viewing angles of the virtual representation rendered in step 123. As schematically depicted in FIG. 1, the viewing angles added at step 102 are selectable by a game player. In particular, the game player may select different viewing angles in real-time, which are added into the virtual scene at step 102.

Significantly, generating virtual scenes 193 with additional viewing angles of virtual representation 192 at step 102 generates viewing angles beyond viewing angles captured by cameras 190. The viewing angles added at step 102 need not and most often do not correspond to viewing angles of real scene 191 captured by cameras 190. In fact, a game player may select viewing angles from nearly an infinite number of positions, which are added in real-time at step 102. Thus, a game player may view virtual representations of an actual scene from nearly any perspective, position, and angle after the selected viewing angle is added at step 102.

As shown in FIG. 4, generating virtual scenes at step 102 includes multiple steps. For example, step 130 of the process for generating virtual scenes at step 102 includes repeating the method for creating a virtual representation in steps 120-123 at selected intervals. Executing step 130 yields time-shifted virtual representations. The three-dimensional Gaussians are replaced in each repetition at step 130 to provide new three-dimensional Gaussians more reflective of objects in each interval of time.

In method 100, the positions of the cameras used to capture the actual scene are used when replacing the three-dimensional Gaussians as part of creating virtual scenes at step 102. The positions of the cameras are used as alignment points to establish relative positions of the old and new Gaussians. The alignment information derived from the position of the cameras helps correlate more accurately where the new Gaussians should be located relative to the old Gaussians.

The selected intervals used in step 130 may be referred to as chunks of time. The chunks of time may be selected to balance processing load, rendering time, and image accuracy. In the present example, the selected interval is initially set at 10 seconds, but could be longer or shorter durations.

Of note, the selected interval in the present example is dynamically adjusted. The selected interval is dynamically adjusted to be longer or shorter chunks of time based on how well the three-dimensional Gaussians are determined to reflect the actual objects in the actual scene. When comparison functions indicate that the three-dimensional Gaussians do not adequately correspond to actual objects in a scene per a given tolerance or deviation threshold, the selected interval is dynamically adjusted to be a shorter time interval.

At step 131, the time-shifted virtual representations created in step 130 are combined. Combining the time-shifted virtual representations at step 131 yields virtual scenes. Any currently known or later developed method for combining time-shifted virtual representations may be utilized at step 131.

### Associating Labels with the Virtual Scenes

Step 103 involves associating labels with the virtual scenes generated at step 102. Associating labels with the virtual scenes at step 103 enables a game player to reference different virtual scenes within an interactive game. Additionally or alternatively, labels associated with virtual scenes at step 103 may allow a game player to selectively access different virtual scenes by name as part of an interactive game.

The labels associated with virtual scenes at step 103 may be descriptive or purely functional. For example, if a virtual scene was of a golfer named Tom hitting a tee shot on hole three of a golf course, the label may be Tom Tee Shot Hole 3. Alternatively, the label could be a purely functional serial number, such as 21842, serving as a record identifier in a data table.

### Dynamically Adding Visual Effects

Adding visual effects at step 104 to the virtual scenes generated at step 103 functions to enhance and/or embellish the virtual scene. The visual effects may provide additional information, add clarity, and/or increase the entertainment value of a virtual scene.

A wide variety of visual effects may be added at step 104. For example, flashing lights or highlight colors may be added to an object of interest in a scene. For a golf scene, a trace of a golf ball in flight may be added to a scene to assist the user perceive where in space the ball is travelling. For a boxing scene, sparks, impact lines, or colors may be added near a boxing glove or portion of a boxer's body to signify that a punch was landed.

In the present example, visual effects are dynamically added at step 104. However, the visual effects may be added and remain unchanged over time as well.

In method 100, selected visual effects added at step 104 are associated with a permanent location in a game map generated at step 108. For example, visual effects in the form of fireworks may be added at step 104 at a finish line location in a game map to celebrate that the finish line location within the game map has been reached. The reader should understand that some visual effects may be associated with permanent locations within a game map while other visual effects are not associated with permanent locations. For example, certain visual effects may be associated with game player actions, time or duration based events, or random events.

### Adding Graphics

Adding graphics at step 105 to the virtual scenes generated at step 103 also functions to enhance and/or embellish the virtual scene. The graphics added may provide additional information, add clarity, and/or increase the entertainment value of a virtual scene. In some instances, the graphics added serve as advertisements or to highlight sponsorship of a scene.

A wide variety of graphics may be added at step 105. For example, a score board display may be presented to inform the game player of the relevant score of a sport event scene. A graphic in the form of a logo and/or slogan may be added for advertising or sponsorship purposes. In some instances, a graphic is added at step 105 to assist a game player to navigate a virtual scene or the interactive game as a whole.

In the present example, graphics are dynamically added at step 105. However, graphics may additionally or alternatively be added and remain unchanged over time as well.

### Receiving Audio Data

Receiving audio data at step 106 enables sounds to accompany the visual aspects of the virtual scenes. In method 100, the audio data received at step 106 includes audio data corresponding to sounds captured from the actual scene. When audio data corresponding to sounds captured from the actual scene are synced with the virtual scene at step 107, the virtual scene has more realism and impact than it would have without the audio data.

The audio data may additionally or alternatively include sounds not associated with the actual scene. For example, the audio data may include artificial sound effects like an explosion to accompany a baseball player hitting a ball with a bat in the actual scene. Narration is another example of audio data that may be received at step 106 that does not correspond to sounds captured from the actual scene.

The audio data received at step 106 may be captured by microphones or other currently known or later developed types of sound capture devices. Additionally or alternatively, the audio data received at step 106 may be synthesized sounds created by a computer.

### Synching the Audio Data

Synching the audio data with the virtual scene at step 107 functions to add sounds from the audio data received a step 106 to the virtual scene at intended times and spatial locations within the virtual scene. In method 100, the audio data is synched at step 107 to match the sounds captured from the actual scene so that the virtual scene has sounds corresponding to the actual scene. The sounds in the virtual scene synched to match the sounds captured from the actual scene adds realism to the virtual scene.

Audio data corresponding to added sounds not associated with the actual scene may be synched at step 107 as well. For example, the sound of an explosion may be synched at step 107 to occur when a baseball player strikes a baseball with a baseball bat.

In addition to time synching, spatial location synching may be employed at step 107. For example, sounds for events occurring to the left of a game player's viewing angle of a virtual scene may be synched to produce sound in just a left headphone the game player is using. Producing the sound in just the left headphone helps establish or reinforce that the sound causing event in the virtual scene is to the left of the game player’s selected viewing angle.

Time and spatial location synching at step 107 may utilize any currently known or later developed technique for audio synching. The synching may occur in real-time or at a time after the actual event occurs.

### Generating a Game Map

Generating a game map at step 108 serves to provide a guide for a game player to navigate the virtual game generated by method 100. In particular, the game map defines a user interface for virtually navigating the three-dimensional, interactive game generated by method 100.

In the present example, the game map generated at step 108 defines game boundaries. The game boundaries limit where a game player may virtually navigate within the three-dimensional, interactive game. However, in some examples, the three-dimensional, interactive game is configured as an open-ended, boundaryless environment, sometimes referred to as an open-world game. In open-world game contexts, the game map does not define boundaries that limit where a game player may navigate, but may define boundaries around different scenes or regions of the game.

In method 100, generating a game map at step 108 is based on camera inputs of an actual scene. However, in some examples the game map generated is not based on camera inputs from an actual scene, but instead is designed for entertainment, interest, or other purposes. For example, the game map may correspond to a fanciful sports arena that does not exist in real life, a setting in outer space, or a historical setting. The game map may be decoratively embellished or may be primarily functional in appearance.

### Associating the Virtual Scenes within the Game Map

Associating virtual scenes generated at step 102 within the game map at step 109 functions to make the virtual scenes into locations within the three-dimensional, interactive game created by method 100. By associating the virtual scenes within the game map at step 109, the virtual scenes become locations a game player may virtually view when navigating the game map. Associating the virtual scenes within the game map as locations at step 109 yields a three-dimensional, interactive game.

In method 100, multiple virtual scenes are generated at step 102, and each of the virtual scenes is associated within the game map at step 109. In other examples, a subset of the virtual scenes is associated as locations within the game map. In certain examples, a single virtual scene is generated at step 102 and that single scene is associated within the game map as a location at step 109.

Associating virtual scenes within the game map at step 109 may be accomplished by any currently known or later developed method. The virtual scene associations within the game map may be conducted in real-time or a period of time after an actual event. In some examples, the virtual location associations within the game for the virtual scenes is affirmatively selected while in other examples the associations are randomly made. In certain examples, a function is used to associate virtual scenes as locations within the game map according to predetermined parameters.

### Associating Fees with the Virtual Scenes

Associating fees with virtual scenes at step 110 functions to monetize the three-dimensional, interactive game generated by method 100. Associating fees with the virtual scenes is optional and provides a way for game developers or content creators to recoup costs and/or utilize method 100 for profit-making purposes. In method 100, selected virtual scenes have fees associated with them at step 110, and a game player must pay the associated fees to virtually view the selected virtual scenes with fees associated with them.

The framework for the fee associations varies in different examples. In some examples, each virtual scene has an individual fee. In other examples, all virtual scenes have the same fee amount associated with them. In select examples, a user pays a fee to play the three-dimensional, interactive game and can access as many virtual scenes as desired for no additional fee. In certain examples, select virtual scenes have a fee associated with them at step 110 while other virtual scenes are free to access.

### Setting Levels for the Virtual Game

Setting levels for the virtual game at step 111 serves to provide a conceptual layer of organization to the three-dimensional, interactive game. The levels may be set to encompass a collection of related virtual scenes within a game map.

For example, a level may be set at step 111 for a collection of virtual scenes related to a particular group of professional golf players playing a particular hole. The level may be for hole number three and include virtual scenes of each player taking shots throughout hole number three. Another level may be set at step 111 for the same group of golfers playing hole number four.

The conceptual framework for the levels will vary in different contexts and may be based on the subject matter of the actual scene underlying the virtual scenes. For a football game example, a level may be set at step 111 to include a collection of virtual scenes depicting plays of a first team’s initial drive. A second level may be set to include a collection of virtual scenes depicting plays of an opposing team’s initial drive. Subsequent levels may represent collections of virtual scenes corresponding to plays in each team's subsequent possessions.

### Adding a Real-Time Rendering Algorithm

Adding a real-time rendering algorithm to the three-dimensional, interactive game at step 112 facilitates a game player navigating the game map generated at step 108. In particular, adding the rendering algorithm at step 112 enables a game player to navigate the game map in real-time. Further, the real-time rendering algorithm added at step 112 enables a game player to change viewing perspectives of the virtual scenes in real-time.

Navigating the game map may be accomplished with a variety of means. For example, the game map and real-time rendering algorithm may be configured to allow a game player to navigate the game map with a game controller, keyboard inputs, mouse inputs, touch screen inputs, and/or device buttons. In some instances, voice inputs or motion detection is used for navigating the game map. Navigation may utilize any currently known or later developed means for game and virtual environment navigation.

The rendering algorithm added at step 112 may be any currently known or later developed algorithm for rendering three-dimensional graphics in real-time. The rendering algorithms may utilize graphics processing units and other processing units of a computing device to render graphics in the virtual game in real-time.

### Distributing the Virtual Game

Distributing the three-dimensional, interactive game at step 113 functions to provide game players with access to the game. Game player access to the game is facilitated by the game distribution at step 113 accounting for device and controller compatibility considerations for different devices and controllers used by particular game players.

With reference to FIG. 5, the reader can see that distributing the game at step 113 includes multiple steps. At step 140, a game playing device of a game player to which the game is to be distributed is identified. For example, the method may identify at step 113 that a game player is utilizing a Sony® PlayStation® game console to play or experience the game to be distributed.

The identification at step 113 may be accomplished by detecting information about the game player’s device when communicating data with the device, such as a request from the device to download or stream the game. Additionally or alternatively, the game player may have an account with information about his or her device and the device information in the game player’s account may be referenced at step 113. In some instances, game players affirmatively specify the device that will be used to interact with the game in a form when requesting access to the game.

With continued reference to FIG. 5, step 141 involves adding operating instructions to the game. The operating instructions added at step 141 are selected to make the game compatible with the game playing device of the game player identified at step 140. Different devices often have different operating systems and operating parameters, and the operating instructions added at step 141 serve to enable the game to function properly on a given device identified at step 140.

At step 142, interaction instructions are added to the game. The interaction instructions added at step 142 function to make the game compatible with a controller used by the game playing device of the game player identified at step 140. Different controllers have different input methods and features, and the interaction instructions added at step 142 account for the particular methods and features of given controller.

In many instances, game playing devices will utilize a single controller and the controller information will be automatically determined once the game playing device is identified at step 140. However, in some instances, information about the controller used by the game player is identified separate from the game playing device. For example, a given game console may have multiple controller options, and the particular controller option utilized by a game player may be determined.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method for generating a three-dimensional, interactive game from camera inputs, comprising:
creating a virtual representation of an actual scene captured by camera inputs, creating a virtual representation including: receiving image data of the actual scene from at least two cameras, the image data including image frames from each camera; processing the image data to generate three-dimensional point clouds representing objects in the actual scene for each image frame; rendering the three-dimensional point clouds into intermediate images comprised of three-dimensional Gaussians representing objects in the actual scene for each image frame; andprocessing the intermediate images with a deformation field to refine the three-dimensional Gaussians that represent objects in motion in the actual scene to yield the virtual representation; generating a virtual scene that includes additional viewing angles of the virtual representation selectable by a game player, generating a virtual scene including: repeating the method for creating a virtual representation at selected intervals to yield time-shifted virtual representations; andcombining the time-shifted virtual representations to yield the virtual scene; generating a game map from camera inputs, the game map defining a user interface for virtually navigating the three-dimensional, interactive game; andassociating the virtual scene within the game map as a location a game player may virtually view when virtually navigating the game map to yield a three-dimensional, interactive game.

2. The method of claim 1, further comprising:
creating multiple virtual scenes; and associating the multiple virtual scenes within the game map.

3. The method of claim 1, further comprising adding a visual effect to the virtual scene.

4. The method of claim 3, wherein the visual effect is associated with a permanent location in the game map.

5. The method of claim 3, wherein the visual effect is dynamically added to the virtual scene.

6. The method of claim 1, further comprising adding graphics to the virtual scene.

7. The method of claim 1, wherein the game map defines game boundaries that limit where a game player may virtually navigate within the three-dimensional, interactive game.

8. The method of claim 1, further comprising associating a label with the virtual scene.

9. The method of claim 1, further comprising setting levels for the three-dimensional, interactive game.

10. The method of claim 1, wherein creating a virtual representation of an actual scene occurs in real-time from live camera inputs.

11. The method of claim 10, wherein generating the virtual scene with additional viewing angles of the virtual representation occurs in real-time.

12. The method of claim 1, further comprising distributing the three-dimensional, interactive game to game players.

13. The method of claim 12, wherein distributing the three-dimensional, interactive game to game players includes identifying a game playing device of a game player.

14. The method of claim 13, wherein distributing the three-dimensional, interactive game to game players includes adding operating instructions to the three-dimensional, interactive game compatible with the identified game playing device of the game player.

15. The method of claim 13, wherein distributing the three-dimensional, interactive game to game players includes adding interaction instructions to the three-dimensional, interactive game compatible with a controller used by the identified game playing device of the game player.

16. The method of claim 1, further comprising:
receiving audio data corresponding to sounds captured from the actual scene; and synching the audio data with the virtual scene to match the sounds captured from the actual scene.

17. The method of claim 1, wherein generating the virtual scene with additional viewing angles of the virtual representation generates viewing angles beyond viewing angles captured by the camera inputs.

18. The method of claim 1, further comprising adding a real-time rendering algorithm to the three-dimensional, interactive game enabling a game player to navigate the game map.

19. The method of claim 18, wherein the real-time rendering algorithm enables a game player to select a perspective for viewing the virtual scene in real-time.

20. The method of claim 1, further comprising associating a fee with the virtual scene in the game map, payment of the fee being required for a game player to virtually view the virtual scene.
